(19) United States
(12) Patent Application Publication
(10) Pub. No.: US 2008/0252730 A1
(43) Pub. Date: Oct. 16, 2008

(54) Infrared sensitive security lighting system

(75) Inventor: Siu Chi Hong, Kowloon (HK)

Correspondence Address: D'AMBROSIO & ASSOCIATES, P.L.L.C., 10260 WESTHEIMER, SUITE 465, HOUSTON, TX, 77042, US

(73) Assignee: WINFIELD VISION DEVELOPMENT (HOLDING) LTD.

(21) Appl. No.: 11/975,552

(22) Filed: Oct. 19, 2007

(30) Foreign Application Priority Data
Apr. 10, 2007 (CN) 2007 2011 9418.X

(51) Int. Cl. H04N 7/18; G08B 13/18

(52) U.S. Cl. 348/155; 340/567

(57) ABSTRACT

A motion triggered digital security system that includes a an infrared motion sensor, a light sensor, an image sensor, and an illuminator. Upon the detection of motion the system determines the level of light present, and if needed the illuminator is initiated. The image sensor then acquires digital images in the form of still images or video clips which are saved on a memory card.

### CROSS REFERENCE TO RELATED APPLICATION

The present application claims priority from Chinese application No. 200720119418.X filed Apr. 10, 2007.

### FIELD OF THE INVENTION

Embodiments of the present invention generally relate to a monitoring system, and more particularly to a monitoring system which is capable of recording digital images upon activation by an infrared sensor.

### BACKGROUND

Conventional monitoring systems typically include video cameras, video recorders, and monitors. Storage of the video images is often performed by recording the images to video tapes which require continuously exchanging and storing tapes. Digital monitoring systems that can digitally store digital images on memory cards have been disclosed. However, these systems do not monitor the light present and are not adapted to initiate an illuminator upon low light conditions.

Consequently, there is a need for a compact security monitoring system that can provide sufficient lighting to obtain clear digital images.

### SUMMARY

The compact security monitoring system of the present invention functions to detect motion and capture an image of the object causing the motion. Advantageously, the present monitoring system also determines the amount of light present and whether or not that amount of light is adequate for imaging. If the light present is not adequate, the system can turn on an illuminator to provide the additional lighting necessary for the digital image module to create a good quality picture. The present invention also acquires digital images, and stores the digital images on a memory card for future viewing to provide a sophisticated security monitoring system.

One embodiment of the invention comprises a motion triggered digital security system which includes a housing, a digital signal processor disposed inside the housing, a passive infrared motion sensor disposed on the housing and in electronic contact with the digital signal processor, a light sensor disposed on the housing and in electronic contact with the digital signal processor, an image sensor adapted to obtain digital images disposed on the housing and in electronic contact with the digital signal processor, and a means for display disposed on the housing and in electronic contact with the digital signal processor, in which the display is adapted to display digital security system status information. The system also comprises an illuminator disposed outside the housing and in electronic contact with the digital signal processor and means for connecting the illuminator to the housing. Also provided is a Universal Serial Bus socket disposed on the housing and in electronic contact with the digital signal processor, in which the Universal Serial Bus socket is adapted to receive a Universal Serial Bus cable for uploading the digital images to a personal computer, and a memory card slot disposed on the housing and in electronic contact with the digital signal processor. The memory card slot is adapted to receive a digital memory card for storage of the digital images acquired by the image sensor. One unique aspect of this invention is that the digital signal processor, the passive infrared motion sensor, the light sensor, the image sensor, the display module, the Universal Serial Bus socket, and the memory card slot are sized to fit within the housing.

In one embodiment of this invention, the security system further comprises a first amplifier connecting the light sensor to the digital signal processor. The first amplifier is adapted to amplify a first signal from the light sensor to the digital signal processor to increase or decrease the amount of required lighting. A light sensor control can be disposed on the housing and is adapted to adjust a sensitivity of the light sensor to light. The security system can further comprise a second amplifier connecting the passive infrared motion sensor control to the digital signal processor, the second amplifier adapted to amplify a second signal from the passive infrared motion sensor to the digital signal processor. Similarly, a passive infrared motion sensor control can be disposed on the housing that is adapted to adjust a sensitivity of the passive infrared motion sensor to motion.

In one aspect, the means for display comprises a liquid crystal display. The digital memory card can be selected from any number of memory card devices including a Secure Digital card, a Secure Digital High Capacity card, a CompactFlash card, a Memory Stick card and an xD-Picture Card.

Another aspect of this invention addresses the problem of connecting the housing to a surface and connecting the illuminator to the housing and/or to a surface. One embodiment comprises a means for mounting the housing onto a surface such as a wall or power junction box. The security system also comprises a means for connecting the illuminator to the housing, i.e. a connector such as a bracket or bracket mount is attached both to the illuminator and the housing and then fastened to a surface of a wall or a power junction box. The illuminator connector can be the same as the connecting means used to mount the housing to a surface. Alternatively, the connecting means adapted to mount the housing to a surface is different from the connector used to mount the illuminator.

The system further comprises a means for time and date keeping in electronic contact with the digital signal processor. The time and date can then be imbedded onto the digital image.

Another embodiment of the invention provides a method for monitoring an area for possible intruders. This method uses a digital signal processor disposed inside a housing. A passive infrared motion sensor is also provided to detect motion; the motion triggers the infrared motion sensor to send a first signal to the digital signal processor. The method further includes using a light sensor disposed on the housing. The light sensor is also in electronic contact with the digital signal processor to measure an ambient light intensity, in which the light sensor sends a second signal to the digital signal processor. The method further includes using the digital signal processor to compare the second signal to a predetermined value, when the second signal is lower than the predetermined value, the digital signal processor engages an illuminator disposed outside the housing to provide the necessary intensity of lighting required to enable to security system to produce images of the object triggering the motion sensor. The digital signal processor then engages an image sensor disposed on the housing to obtain one or more digital images, and directs the digital images to one or more digital memory cards. The digital memory cards are positioned in a memory card slot disposed on the housing. The digital signal processor, the passive infrared motion sensor, the light sensor, the image sensor and the memory card are sized to fit within the housing.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top-front perspective view of a security system, according to an embodiment of the invention.

FIG. 2 is a bottom-front perspective view of a security system, according to an embodiment of the invention.

FIG. 3 is a bottom-front view of a security system, according to an embodiment of the invention.

FIG. 4 is a block diagram of a security system, according to an embodiment of the invention.

FIG. 5 is a view of a bracket arrangement for a security system, according to an embodiment of the invention.

### DETAILED DESCRIPTION OF THE INVENTION

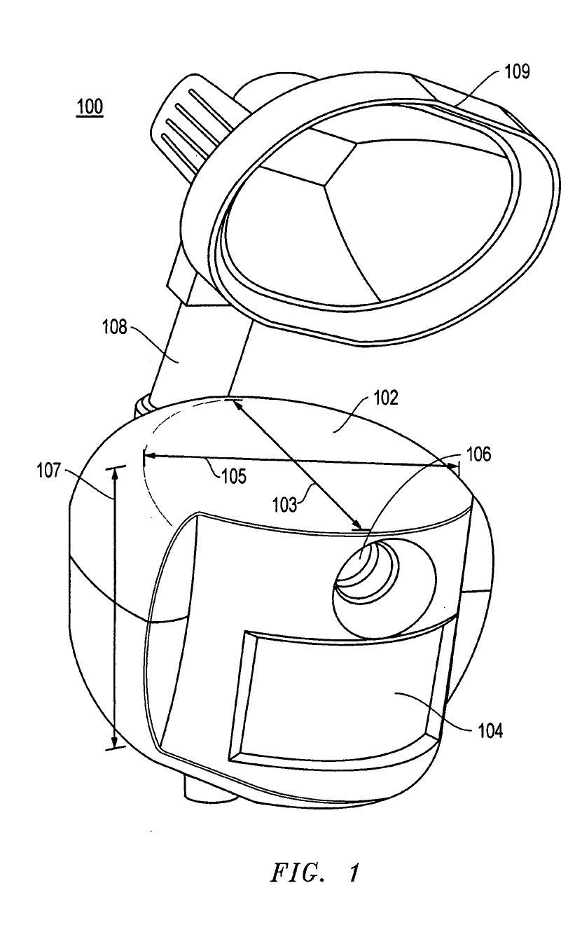

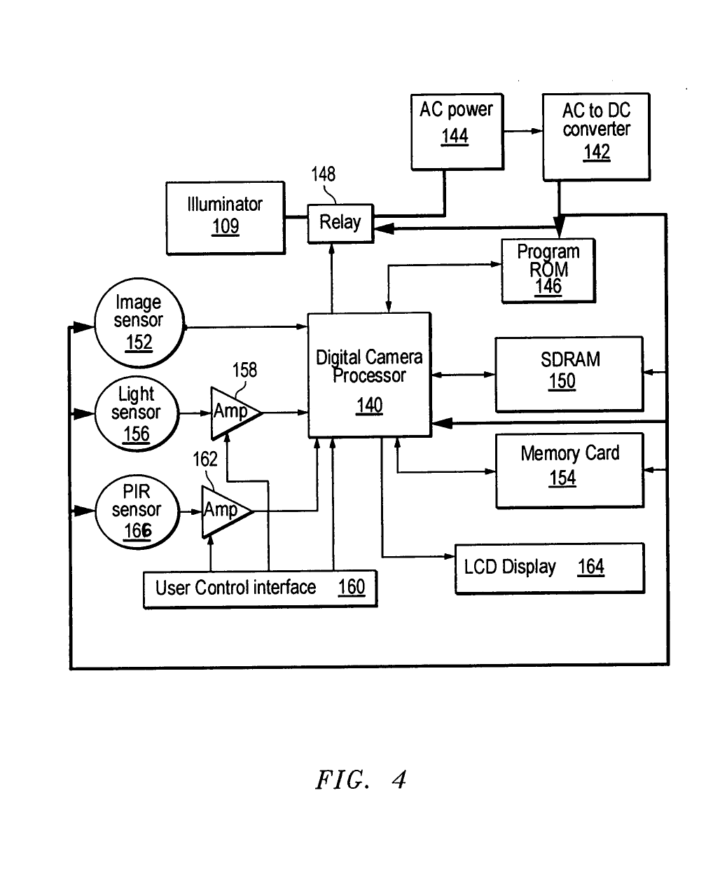

FIG. 1 is a top-front view of a security system 100, according to an embodiment of the invention. The security system 100 includes a housing 102. The housing 102 may be made from any suitable material, such as aluminum, stainless steel, titanium, metal alloys, composite materials, and plastics. In one embodiment, referring to FIGS. 1 and 4, the housing 102 is manufactured from molded plastic, such as fire rated acrylonitrile butadiene styrene (ABS). On a front side, the housing 102 has a first opening 104 for a motion sensor, such as a passive infrared (PIR) motion sensor 166, and for a light sensor 156, such as a photo diode. On the front side, the housing 102 also has a second opening 106 for an image sensor 152, for example, an optic lens for acquiring images.

A bracket mount 108 is disposed towards a backside of the housing 102. The bracket mount 108 may be made of the same material as the housing 102, and may be used to attach the housing 102 to an illuminator 109, to a wall, or both, via a bracket 172 The bracket mount 108 may be hollow to allow electrical wires to enter the housing 102 in order to both provide power to the security system 100 and to provide an electrical signal from security system 100 to the illuminator 109. The illuminator 109 may be any illuminating device known in the art, such as flood lights, incandescent lights, light emitting diodes, spot lights, lanterns (coach lights), flood lights with compact fluorescent lamps, and the like.

In an embodiment of the invention, the housing 102 may be in an oval-like shape having a length 103 between about 50 mm and about 200 mm, preferably between about 75 mm and about 150 mm. In on embodiment the length 103 is about 100 mm. The oval shape may have a width 105 between about 40 mm and about 160 mm, preferably between about 60 mm and about 120 mm. In one embodiment the width 105 is about 85 mm. Housing 102 may have a height 107 between about 45 mm and about 180 mm, preferably between about 60 mm and about 140 mm. In one embodiment the height 107 is about 120 mm.

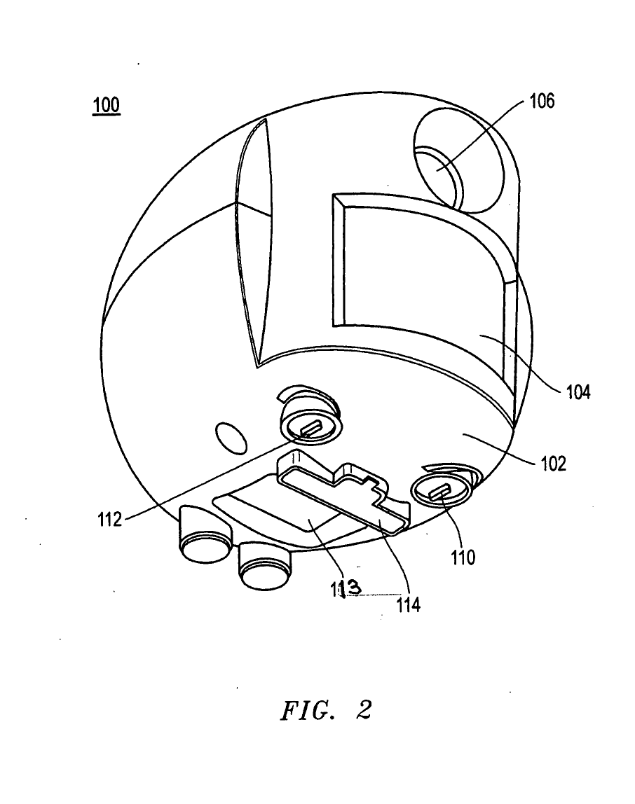

FIG. 2 is a bottom-front perspective view of the security system 100, according to an embodiment of the invention. On a bottom end of the housing 102 are a third opening 113 for a display module, a fourth opening for receiving a first control button 110, a fifth opening for receiving a second control button 112, and a sixth opening 114 for a memory card reader and a Universal Serial Bus (USB) socket.

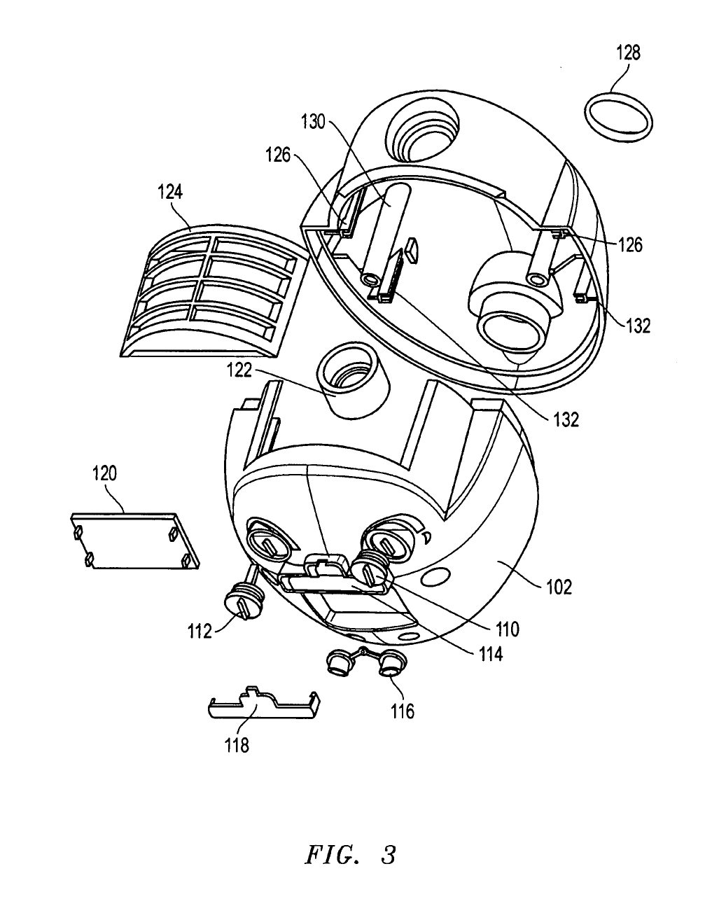

FIG. 3 is another view of the security system 100, according to an embodiment of the invention. In this embodiment, the housing 102 comprises two or more molded plastic parts, such as ABS, held together by screws through channels 130. Two such channels 130 are depicted in FIG. 1, however any number of the channels 130 may be used as needed. Sets of grooves 126 and 132 are disposed within the housing 102, and are used to hold in place electronic circuit boards (not shown). For example, the grooves 126 may hold in place a circuit board (not shown) for the passive infrared motion sensor 166 and for an image sensor 152, such as a charge-coupled device (CCD) sensor or a complementary metal-oxide-semiconductor (CMOS) sensor. The grooves 132 may hold in place a circuit board (not shown) which may include a digital camera processor, read-only memory (ROM), dynamic random access memory (DRAM), and other components.

A PIR bracket 124 is attached to the housing 102 over the first opening 104 in order to provide protection for the PIR motion sensor. A lens ring 122 fits in second opening 106 and encompasses the lens or lenses used to provide optical images to the image sensor 152. A waterproof o-ring ensures that no water enters the security system 100 via second opening 106, and may be made from any suitable materials, such as rubber. A display module 120 is mounted in the third opening 113. The display module 120 may hold an embedded liquid crystal display (LCD). The status of the security system 100 and images taken by the system may be displayed on the LCD. The viewer may adjust the security system 102 by means of control buttons 110 and 112 and control buttons 116.

FIG. 4 is a block diagram of the security system 100, according to another embodiment of the invention, illustrating how the various components are connected. A digital camera processor 140 is powered with DC current from an AC/DC current converter 142 that is fed an AC current from an AC power source 144, such as a household electrical outlet. The digital camera processor 140 controls the security system 100, and may include a time and date module for stamping the time and date of capturing the image on the image itself. A dynamic random access memory module 146 is disposed inside the housing and is in electronic contact with the digital signal processor. The program ROM 146 is also powered with DC current from the AC/DC current converter 142, and is in communication with the digital camera processor 140. Program ROM 146 includes the program code used by the digital camera processor 140 in operating and controlling the security system 100.

The illuminator 109 is supplied with an AC current from the AC power source 144, via a relay 148 which switches the AC current to the illuminator 109 on or off as determined by digital camera processor 140. SDRAM provides operating memory for the digital camera processor 140 and is powered by the DC current from converter 142. An image sensor 152, such as a CCD or CMOS sensor is controlled by the digital camera processor 140 and can acquire both digital still images and movie clips which are temporarily stored in the SDRAM 150. For permanent storage of the still images and movie clips, a memory card 154 is in electronic contact with the digital camera processor 140. The digital memory card can be selected from any number of memory card devices including a Secure Digital card, a Secure Digital High Capacity card, a CompactFlash card, a Memory Stick card and an xD-Picture Card. A user may remove the memory card 154 and insert the memory card 154 into a memory card reader attached to a personal computer or printer for downloading or printing the images.

Alternatively, the still images and movie clips may be accessed and stored on a personal computer attached to the security system 100 via a USB cable. If the memory card has all its physical memory used by the digital images, the digital camera processor 140 may delete older images to make room for the new images, emulating a virtual tape loop.

A light sensor 156 is in connection with the digital camera processor 140 via a first amplifier 158. A first signal from the light sensor 156 passes through the first amplifier 158 and is sent to the digital camera processor. The sensitivity of light sensor 156 to light, or the adjustment of the magnification ratio of the first amplifier, may be adjusted using a user control interface 160, such as a light sensor control or a passive infrared motion sensor control. A passive infrared motion sensor 166 is in connection with the digital camera processor 140 via a second amplifier 162. The adjustment of the magnification ratio of the second amplifier 162 may also be adjusted using user control interface 160. FIGS. 3 and 4 illustrate one embodiment of the user control interface (light sensor controls or a passive infrared motion sensor controls) in the form of control buttons 110 and 112 and the control buttons 116.

Both the light sensor 156 and the PIR sensor 166 may be powered by the DC current from converter 142. An LCD 164 is also connected to the digital camera processor 140, and may be used for displaying the settings and the status of the security system 100. The LCD 164 can also display the images acquired and stored on the memory card 154.

When turned on, the PIR sensor 166 is adapted to trigger a signal through sensing any movement of a heat source, such as an intruding human being. The second amplifier 162 amplifies the signal from the PIR sensor 166, and the signal is received in the digital camera processor 140. The digital camera processor 140 also receives an amplified signal from the light sensor 156. If the digital camera processor 140 determines that the signal from the image sensor 152 is below a predetermined intensity, i.e. that more light is needed for a satisfactory image, the digital camera processor 140 submits a signal to relay 148 to switch on the AC power to the illuminator 109 while the digital camera processor 140 simultaneously submits a signal to the image sensor 152 to acquire digital images in the form of still images or movie clips.

The digital images are then submitted to the digital camera processor 140 where the digital camera processor 140 may add the date and time provided by the time keeping module to the digital images. The date and time information may be embedded on the digital images, or saved as a file name indicating date and time. The digital camera processor 140 then may save the digital images on the memory card 154. Alternatively, real time monitoring is possible on a personal computer by attaching the security system 100 to the computer via a USB cable, or the like. Once the PIR sensor 166 does not detect any more movement from the heat source, i.e. the intruder is no longer present, the digital camera processor 140 submits a signal to the relay 148 to shut off the power to the illuminator 109. Simultaneously, the digital camera processor 140 submits a signal to the image sensor 152 to cease acquiring the digital images.

In a further embodiment of the invention, security system 100 may also include a microphone in communication with the digital camera processor in order to record audio as well as the digital images. Thus, movie clips including sound may be acquired as well. Furthermore, in another embodiment, an alarm may be included in security system 100. An alarm may be connected to the security system 100, and will be triggered automatically while the illuminator 109 is turned on and the images are acquired.

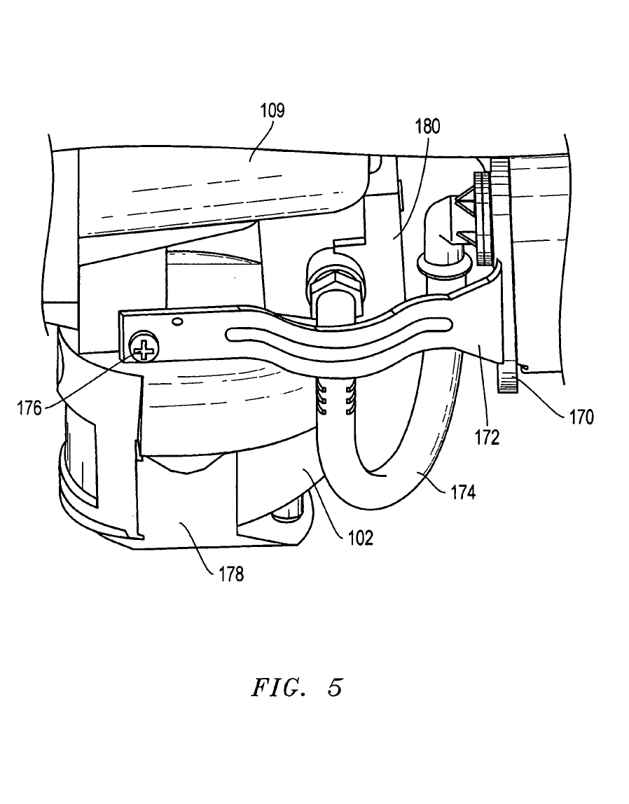

FIG. 5 depicts security system 100 as mounted on a surface 170 such as a wall or a standard power junction box, which generally are built into walls, according to an embodiment of the invention. In one embodiment of the present invention, a bracket mount 108, FIG. 1, secures the housing 102 to the illuminator 109. The illuminator 109 with the housing attached is then mounted to the surface 170 by means of a bracket 172. The bracket 172 is fastened to the illuminator 109 via a fastening device 176, such as a bolt or a screw and then mounted onto the surface 170. The bracket may be made of the same material as the housing 102, such as aluminum, stainless steel, titanium, metal alloys, composite materials, and plastics. In one embodiment, the bracket 172 is made from a steel plate. The illuminator 109 is connected to a power source box 180 which includes the AC/DC current converter 142 and provides AC current to the illuminator 109 and DC current to the other components of security system 100. A power conduit 174 is connected to the power source box 180 and a power outlet of a standard power junction box. The power source box 180 is attached to the housing 102 through the bracket mount 108 of FIG. 1. A shield 178 is disposed to cover the bottom portion of housing 102, and may be fastened as a clip on the housing 102.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

1. A motion triggered digital security system, comprising:
a housing;
a digital signal processor disposed inside the housing;
a passive infrared motion sensor disposed in the housing and in electronic contact with the digital signal processor;
a light sensor disposed in the housing and in electronic contact with the digital signal processor;
an image sensor, adapted to obtain digital images, disposed in the housing and in electronic contact with the digital signal processor;
a means for display disposed in the housing and in electronic contact with the digital signal processor, wherein the means for display is adapted to display digital security system status information;
an illuminator disposed outside the housing and in electronic contact with the digital signal processor;
means for connecting the illuminator to the housing;
a Universal Serial Bus socket disposed in the housing and in electronic contact with the digital signal processor, wherein the Universal Serial Bus socket is adapted to receive a Universal Serial Bus cable for uploading the digital images to a personal computer;
a memory card slot disposed in the housing and in electronic contact with the digital signal processor, wherein the memory card slot is adapted to receive a digital memory card for storage of the digital images acquired by the image sensor;
wherein the digital signal processor, the passive infrared motion sensor, the light sensor, the image sensor, the means for display, the Universal Serial Bus socket, and the memory card slot are sized to fit within the housing.

2. The system of claim 1, further comprising a first amplifier connecting the light sensor to the digital signal processor, wherein the first amplifier is adapted to amplify a first signal from the light sensor to the digital signal processor.

3. The system of claim further comprising a light sensor control disposed on the housing, the light sensor control adapted to adjust a sensitivity of the light sensor to light.

4. The system of claim 1, further comprising a second amplifier connecting the passive infrared motion sensor control to the digital signal processor, wherein the second amplifier is adapted to amplify a second signal from the passive infrared motion sensor to the digital signal processor.

5. The system of claim 4, further comprising a passive infrared motion sensor control disposed on the housing, the passive infrared motion sensor control adapted to adjust a sensitivity of the passive infrared motion sensor to motion.

6. The system of claim 1, wherein the digital memory card is at least one of a Secure Digital card, a Secure Digital High Capacity card, a CompactFlash card, a Memory Stick card and an xD-Picture Card.

7. The system of claim 1, wherein the means for display comprises a liquid crystal display.

8. The system of claim 1, further comprising a dynamic random access memory module disposed inside the housing and in electronic contact with the digital signal processor.

9. The system of claim 1, further comprising an AC/DC current converter disposed inside the housing.

10. The system of claim 1, wherein the means for connecting the illuminator to the housing comprises a connector.

11. The system of claim 10, wherein the connector is adapted to connect both the illuminator and the housing to a surface.

12. The system of claim 11, further comprising a means for connecting the housing, the means for connecting the housing adapted to connect the housing to a surface.

13. The system of claim 1, further comprising a means for time and date keeping in electronic contact with the digital signal processor.

14. The system of claim 11, wherein the housing comprises two or more parts adapted to be fastened together.

15. The system of claim 14 wherein the two or more parts comprise molded fire rated acrylonitrile butadiene styrene.

16. The system of claim 1, wherein the housing has a length between about 50 mm and about 200 mm, a width between about 40 mm and about 160 mm, and a height between about 45 mm and about 180 mm.

17. The system of claim 1, wherein the length of the housing is between about 75 mm and about 150 mm, the width between about 60 mm and about 120 mm, and the height between about 60 mm and about 140 mm.

18. A method for monitoring an area, comprising:
supplying a digital signal processor disposed inside a housing;
using a passive infrared motion sensor disposed in the housing to detect motion, wherein the motion triggers the infrared motion sensor to send a first signal to the digital signal processor;
using a light sensor disposed in the housing and in electronic contact with the digital signal processor to measure an ambient light intensity, wherein the light sensor sends a second signal to the digital signal processor;
using the digital signal processor to compare the second signal to a predetermined value, wherein upon the second signal being lower than the predetermined value the digital signal processor engages an illuminator disposed outside the housing;
using the digital signal processor to engage an image sensor disposed in the housing to obtain one or more digital images; and
directing the one or more digital images to a digital memory card positioned in a memory card slot disposed in the housing, wherein the digital signal processor, the passive infrared motion sensor, the light sensor, and the memory card are sized to fit within the housing.

19. The method of claim 18, further comprising uploading the one or more digital images to a personal computer via a Universal Serial Bus cable connected to a Universal Serial Bus socket disposed on the housing and in electronic contact with the digital signal processor.

20. The method of claim 18, further comprising imprinting a date and time on the digital image.

21. The method of claim 18, wherein the one or more digital images comprise a series of images in a film clip.

22. The method of claim 18, further comprising amplifying the first signal from the passive infrared motion sensor.

23. The method of claim 18, further comprising amplifying the second signal from the light sensor.

24. The method of claim 23, further comprising adjusting the amplification of the first and second signals.

25. A motion triggered digital security system, comprising:
a housing;
a digital signal processor disposed inside the housing;
a passive infrared motion sensor disposed in the housing and in electronic contact with the digital signal processor;
a light sensor disposed in the housing and in electronic contact with the digital signal processor;
an image sensor, adapted to obtain digital images, disposed in the housing and in electronic contact with the digital signal processor;
a means for display disposed in the housing and in electronic contact with the digital signal processor, the means for display adapted to display digital security system status information;
an illuminator disposed outside the housing and in electronic contact with the digital signal processor;
a first amplifier connecting the light sensor to the digital signal processor, a light sensor control disposed on the housing, the light sensor control used to adjust a sensitivity of the light sensor to light; and
a second amplifier connecting the passive infrared motion sensor control to the digital signal processor, a passive infrared motion sensor control disposed on the housing to adjust a sensitivity of the passive infrared motion sensor to motion;
wherein the digital signal processor, the passive infrared motion sensor, the light sensor, the image sensor, the means for display, the first amplifier, the second amplifier are sized to fit within the housing.
